(19) United States
(12) Patent Application Publication
(10) Pub. No.: US 2019/0227918 A1
(43) Pub. Date: Jul. 25, 2019

(54) METHOD FOR ALLOCATING MEMORY RESOURCES, CHIP AND NON-TRANSITORY READABLE MEDIUM

(71) Applicant: AutoChips Inc., Hefei (CN)

(72) Inventor: KE XU, Hefei (CN)

(21) Appl. No.: 16/198,899

(22) Filed: Nov. 23, 2018

(30) Foreign Application Priority Data
Jan. 22, 2018 (CN) 201810061285.8

(51) Int. Cl. G06F 12/02; G06F 12/10

(52) U.S. Cl. CPC G06F 12/0223; G06F 2212/657; G06F 2212/1044; G06F 12/10

(57) ABSTRACT

The present disclosure provides a method for allocating memory resources, a chip and a non-transitory readable medium. The method includes: dividing memory resources into primary memory resources and reserved memory resources, wherein the reserved memory resources are reserved for a secondary system; receiving a control information indicating that a mission of the secondary system is completed or not executed; and in response to the control information, updating the reserved memory resources by setting the reserved memory resources as available to a primary system. According to the present disclosure, after the mission of the secondary system is completed or not executed, the reserved memory resources are set as available to the primary system. That is, it is possible to recycle the reserved memory resources for the use of the primary system. Thus, waste of memory resources may be reduced and utilization rate of memory resources may be improved.

### CROSS-REFERENCE TO RELATED APPLICATIONS

The present application claims foreign priority of Chinese Patent Application No. 201810061285.8, field on Jan. 22, 2018 in the State Intellectual Property Office of China, the entire contents of which are hereby incorporated by reference.

### TECHNICAL FIELD

The present disclosure generally relates to the computer technology, and in particular to a method for allocating memory resources, a chip and a non-transitory readable medium.

### BACKGROUND

Start-up of an operating system takes a certain period of time. In some cases, one or more secondary system should be pre-started for accomplishing real time tasks before the start-up process of the operating system is completed. The secondary system also needs some memory resources for its operation. In order to provide necessary memory resources to the secondary system, the physical memory resources may be logically divided into two groups, one for the use of the operating system (i.e., primary system), and the other for the use of the secondary system.

The inventor of the present disclosure has found that, the memory resources reserved for the secondary system will change into an idle state after the tasks of the secondary system or the corresponding system processes have been accomplished. Then the reserved memory resources cannot be recycled for the use of the primary system, which means the primary system cannot manage this portion of memory resources. In other words, these memory resources are wasted, and thereby the memory resources cannot be fully utilized.

### SUMMARY

Accordingly, the present disclosure provides a method for allocating memory resources, a chip and a non-transitory readable medium, and aims to improve the utilization of memory resources.

To solve the above mentioned problem, a technical scheme adopted by the present disclosure is to provide a method for allocating memory resources. The method includes: dividing memory resources into primary memory resources and reserved memory resources, wherein the reserved memory resources are reserved for a secondary system; receiving a control information indicating that a mission of the secondary system is completed or not executed; and in response to the control information, updating the reserved memory resources by setting the reserved memory resources as available to a primary system.

To solve the above mentioned problem, another technical scheme adopted by the present disclosure is to provide chip. The chip includes a processor. The processor is configured to execute program instructions to execute a method for allocating memory resources, and the method includes: dividing memory resources into primary memory resources and reserved memory resources, wherein the reserved memory resources are reserved for a secondary system; receiving a control information indicating that a mission of the secondary system is completed or not executed; and in response to the control information, updating the reserved memory resources by setting the reserved memory resources as available to a primary system.

To solve the above mentioned problem, another technical scheme adopted by the present disclosure is to provide a non-transitory readable medium. The non-transitory medium includes program instructions. When the program instructions are executed by a processor of an electronic device, the processor may perform a method for allocating memory resources. The method includes: dividing memory resources into primary memory resources and reserved memory resources, wherein the reserved memory resources are reserved for a secondary system; receiving a control information indicating that a mission of the secondary system is completed or not executed; and in response to the control information, updating the reserved memory resources by setting the reserved memory resources as available to a primary system.

According to the present disclosure, after the control information indicating that the mission of the secondary system is completed or not executed, the reserved memory resources are set as available to the primary system. That is, it is possible to recycle the reserved memory resources for the use of the primary system. Thus, waste of memory resources may be reduced and utilization rate of memory resources may be improved.

### BRIEF DESCRIPTION OF THE DRAWINGS

In order to clearly explain the technical solutions in the embodiments of the present disclosure, the drawings used in the description of the embodiments will be briefly described below. Obviously, the drawings in the following description are merely some embodiments of the present disclosure. For those of ordinary skill in the art, other drawings may also be obtained based on these drawings without any creative work.

FIG. 1 is a flow chart of a method for allocating memory resources according to an embodiment of the present disclosure.

FIG. 2 is a flow chart of a method for recycling memory resources according to another embodiment of the present disclosure.

FIG. 3 shows an exemplary method for adding the information of reserved memory resources into the primary memory manager according to an embodiment of the present disclosure.

FIG. 4 is a flow chart of a method for reallocating memory resources according to an embodiment of the present disclosure.

FIG. 5 shows different states of a primary memory manager and a secondary memory manager according to an embodiment of the present disclosure.

FIG. 6 is a schematic diagram of a device for allocating memory resources according to an embodiment of the present disclosure.

FIG. 7 is a schematic diagram of a chip according to an embodiment of the present disclosure.

### DETAILED DESCRIPTION

The disclosure will now be described in detail with reference to the accompanying drawings and examples. Apparently, the described embodiments are only a part of the embodiments of the present disclosure, not all of the embodiments. All other embodiments obtained by a person of ordinary skill in the art based on the embodiments of the present invention without creative efforts shall fall within the protection scope of the present invention.

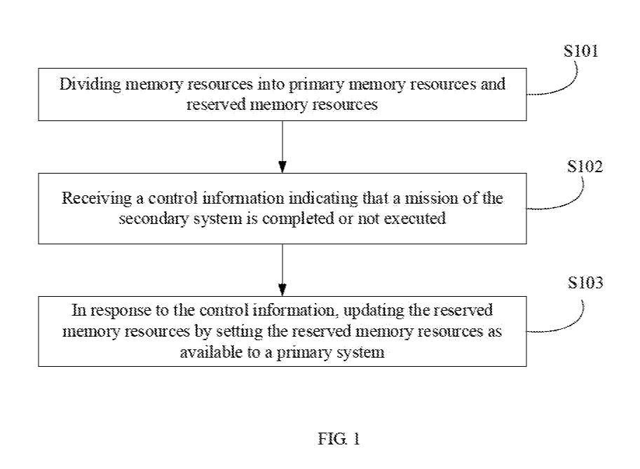

Referring to FIG. 1, FIG. 1 is a flow chart of a method for allocating memory resources according to an embodiment of the present disclosure. The method may be applied, for example, in the embedded on-board system of a vehicle. The method may include following operations described in S101˜S103.

S101: Dividing memory resources into primary memory resources and reserved memory resources. The reserved memory resources are reserved for a secondary system. In some embodiments, the primary system may be a main operating system of the on-board system of a vehicle, and may be utilized for managing programs and system resources. The secondary system may be run by an independent processor and utilized to execute real-time tasks such as displaying reversing video.

In block S101, when the system is powered up, the size of the real physical memory resources may be acquired according to configuration. Then the memory resources may be divided into primary memory resources and reserved memory resources. The reserved memory resources may be the portion of the memory resources reserved for a secondary system to execute tasks. Those of ordinary skill in the art should understand that, in some embodiments, besides the primary memory resources and reserved memory resources, the memory resources may further include some static memory resources which are not modifiable or accessible. The reserved memory resources may be either a continuous set of physical memory resources or multiple blocks of physical memory resources. In some embodiments, there may be several groups of reserved memory resources. When there exists several secondary systems, each secondary system may correspond to respective group of reserved memory resources. Based on data structures and the system configuration, one or more memory manager may be employed correspondingly for dividing and managing the memory resources. Alternatively, the memory resources may be divided by directly modifying the attribute of the memory resources. After the reserved memory resources are defined, the secondary system may access the reserved memory so as to execute tasks.

S102: Receiving a control information indicating that a mission of the secondary system is completed or not executed.

The secondary system may function either based on instructions from the primary system or independently. For instance, the reversing assist system may be a sub-system of an on-board system, or the reversing assist system may function independently from the on-board system. In the latter case, the reversing system may be started up rapidly during the start-up of vehicle so as to assist the reversing operations of driver rather than waiting for the completion of the start-up of the whole on-board system of vehicle. In the block S102, the secondary system may send a control information indicating that the mission of the secondary system is completed to the primary system (i.e., the on-board system), and the primary system may receive the control information correspondingly. The completion of tasks of the secondary system means that the reserved memory resources occupied by the secondary system change into an idle state. In some embodiments, the primary system and the secondary system may be executed by different hardware devices. In this situation, the primary system and the secondary system may communicate with each other by transmitting electrical signals. For example, for two processors sharing a common memory, the processor for executing the secondary system may use its interrupt signal as the mission completion signal of the secondary system, and may transmit the interrupt signal via an interrupt controller between the processors so as to inform another processor for executing the primary system. In other embodiments, the primary system and the secondary system may communicate with each other by transmitting program instruction, which is not limited in the present disclosure.

In other cases, after the whole system is powered up, the secondary system is not requested to execute its tasks. For example, if a vehicle is started but no reversing operation needs to be performed, the reversing system will not execute the corresponding tasks. In this situation, the primary system may monitor the secondary system, or the secondary system may inform the primary system after the primary system is completely started up, such that the primary system may obtain the control information indicating that the mission of the secondary system is not executed (or will not be executed in a certain period of time). Similarly, it means that the reserved memory resources for the secondary system are in an idle state if the tasks of the secondary system are not executed. Thus, when the primary system receives the control information indicating that the mission of the secondary system is completed or not executed, the process of recycling the reserved memory resources may begin.

S103: In response to the control information, updating the reserved memory resources by setting the reserved memory resources as available to a primary system.

After the control information indicating that the mission of the secondary system is completed or not executed is received, in S103, the primary system may update the reserved memory resources by setting the reserved memory resources as available to the primary system. Corresponding to the method for dividing the memory resources described in block S101, the reserved memory resources may be updated by using the memory resource manager or by directly modifying the attribute of the reserved memory resources. When the reserved memory resources are updated to be available to the primary system, the primary system may access the reserved memory resources when executing tasks, e.g., the primary system may execute read or write operation for contents stored in the reserved memory resources. In this way, this part of memory resources reserved for the secondary system may be recycled after the mission of the secondary system is completed or the secondary system does not need to execute the mission. The recycled memory resources as well as other primary memory resources may be utilized by the primary system.

According to the present disclosure, after the control information indicating that the mission of the secondary system is completed or not executed, the reserved memory resources are set as available to the primary system. That is, it is possible to recycle the reserved memory resources for the use of the primary system. Thus, waste of memory resources may be reduced and utilization rate of memory resources may be improved.

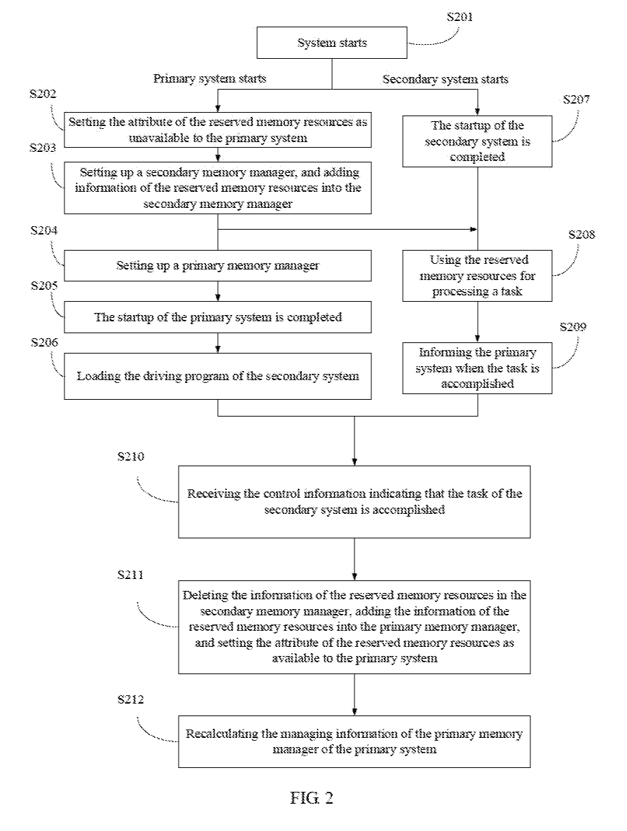

Referring to FIG. 2, FIG. 2 is a flow chart of a method for recycling memory resources according to an embodiment of the present disclosure. The method may include, but not limited to, operations described in following blocks S201˜S212.

S201: Starting up the system.

In this embodiment, the system may include a primary system and one or more secondary system. The secondary system may function independently from the primary system, or operate in response to the indication from the primary system. When the whole system is powered up, the start-up processes of both the primary system and the secondary system may begin. It should be understood that, the start-up time of the secondary system may not be exactly the same as that of the primary system.

S202: Setting the attribute of the reserved memory resources as unavailable to the primary system.

In some embodiments, the attribute of memory resources may be modified so as to define the memory resources. Thus, in S202, the reserved memory resources may be configured as unavailable to the primary system. It should be understood that, the specific method for configuring the reserved memory resources as unavailable to the primary system may be based on the method for managing memory resources and the data structures of the system. In this circumstance, the reserved memory cannot be accessed or utilized by the primary system, and can only be accessed and utilized by the secondary system.

In some embodiments, the page memory management method may be utilized as the memory resources management method. Specifically, a page and a frame may be used as the minimum unit for the virtual memory and physical memory. For a system with page memory management, e.g., the kernel of Linux, the kernel may define multiple pages of memory or memory blocks, and store relative page information in the configuration file of the kernel. The relative page information may include, but not limited to, address, size and storage permission. Accordingly, by setting the storage permission of the page information of the reserved memory resources as unavailable to the primary system, the reserved memory resources may be reserved only for the use of the secondary system.

S203: Setting up a secondary memory manager, and adding information of the reserved memory resources into the secondary memory manager.

The start-up of the primary system needs a certain period of time. In this period of time, one or more secondary system or process may already be started to achieve some real-time tasks. The secondary system (or relative processes) may also need to occupy some memory resources for accomplishing its tasks. In this situation, a secondary memory manager may be employed for managing these memory resources. The secondary memory manager may be configured to store the information of other memory resources except for the primary memory resources, e.g., static memory resources and/or reserved memory resources. In some embodiments, the secondary memory manager may also be utilized for storing information of primary memory resources such as dynamic memory resources. In this situation, the secondary memory manager may be utilized as an early-time memory manager. In block S203, the primary system may set up the secondary memory manager and add information of reserved memory resources into the secondary memory manager so as to manage the reserved memory resources in subsequent steps. In this embodiment, the secondary memory manager may be set up either during the start-up process of the primary system or prior to the primary system. In other embodiments, the secondary memory manager may alternatively be set up after the start-up process of the primary system, which depends on the configuration of the secondary system. The kernel early time memory allocator, memblock, may be an example of the secondary memory manager. The manager memblock may include at least multiple sets (lists or arrays) of information of dynamic memory resources and reserved memory resources. Information of a group of memory resources may be added into the information set of reserved memory resources such that the manager memblock may manage this group of memory resources. It should be understood that, the secondary memory manager may be other types of memory manager having similar functions in other embodiments.

The information of reserved memory resources added into the secondary memory manager may include the identifier, type, addresses (physical addresses, logical addresses or both), or size of the reserved memory resources. In this way, relative information of the reserved memory resources may be acquired by using the secondary memory manager such that the reserved memory resources may be utilized. Optionally, when the page memory management method is utilized, the secondary memory manager may access the page table stored inside or outside the manager so as to convert virtual addresses of the memory resources into physical addresses.

S204: Setting up a primary memory manager, and the primary memory manager is configured to store a primary memory information set which records information of memory resources available to the primary system.

In block S204, the primary memory manager may be set up. The primary memory manager may be utilized for storing a primary memory information set which may record information of memory resources available to the primary system (e.g., dynamic memory resource). The primary memory manager may allow the primary system to manage all the memory resources it can use. During operation, the primary system may use memory resources recorded in the primary memory manger to execute its tasks. The buddy memory allocation may be an example of the primary memory manager. It should be understood that, the primary memory manger may be other managers or data structures capable of managing the primary memory resources or the dynamic memory resources.

Since the reserved memory resources have been set as unavailable to the primary system, the primary memory manager does not take the responsibility to manage these memory resources. After the primary memory manager has been set up, the size of memory resources available to the primary system may be equal to the size of the entire memory resources minus the size of the reserved memory resources. Similarly, when the page memory management method is utilized, the primary memory manager may access the page table stored inside or outside the manager so as to convert virtual addresses of the memory resources into physical addresses.

It should be understood that, the step of defining the reserved memory resources in block S202 may be performed prior to the step of setting up the secondary memory manager and the primary memory manager. The definition of the reserved memory may be stored in a specific data structure such as the kernel configuration file. In this situation, the secondary memory manager and the primary memory manager may access the specific data structure to acquire relative information of the reserved memory resources and the primary memory resources respectively.

S205: The start-up of the primary system is completed.

After the start-up of the primary system has been completed, the primary system may utilize the corresponding primary memory resources to execute tasks. The primary system does not use the reserved memory resources. Thus, the reserved memory resources may be utilized by the secondary system safely. It should be understood that, after the start-up of the primary system is completed, the secondary system may either continue to operate independently of function in response to indications sent by the primary system.

S206: Loading the driving program of the secondary system. The driving program of the secondary system is utilized for communication between the primary system and the secondary system.

In some embodiments, the primary system may load the driving program of the secondary system so as to communicate with the secondary system, that is, to send control indication or notification message to the secondary system. For example, when the secondary system is the embedded system of an external equipment, the primary system may load the driving program of the external equipment so as to identify the external equipment. In another example, when the secondary system and the primary system are both embedded systems of a same device, the driving program may be the function or command for the primary system to call the secondary system. In block S206, the primary system may load the driving program of the secondary system such that the primary system may receive messages from the secondary system in subsequent steps.

S207: The start-up of the secondary system is completed.

As the primary system is being started up, the secondary system may also be started up. The start-up speed of the secondary system which is designed for executing rapid tasks may be faster than that of the primary system. In other words, the secondary system may complete the start-up process earlier than the primary system.

S208: Using the reserved memory resources for processing tasks.

After the start-up process of the secondary system has been accomplished, the secondary system may use the reserved memory resources which are unavailable to the primary system to execute its tasks with the aid of the secondary memory manager. Since the reserved memory resources are reserved, the primary system cannot use the reserved memory resources after it is started up. Thus, there is no interruption when the memory resources are used by the primary system and the secondary system at the same time, and the function of the secondary system may be ensured.

S209: Informing the primary system when the task(s) is accomplished.

In block S209, the secondary system may inform the primary system of a mission completion message after having completed its task or tasks. In some embodiments, the secondary system may work only during the start-up process of the primary system. In this situation, the mission completion message means that the secondary system has finished all its mission and will not function any more. In other embodiment, the secondary system may function intermittently. In this situation, the mission completion message means that the secondary system has completed current tasks, and will change into an idle state and wait for the next mission. Apparently, in both situation as described above, the secondary system will not work in a certain period of time after the completion of tasks. At this time, the reserved memory resources are in the idle state and may be recycled by the primary system. Those of ordinary skill in the art should understand that, the secondary system may inform the primary system by using a control indication or notification message with proper data format, which is not limited in the present disclosure.

S210: Receiving the control information indicating that the task of the secondary system is accomplished.

Correspondingly, the primary system may receive the mission completion message from the secondary system. Thus, the system may acknowledge that the mission of the secondary system is completed and may begin to recycle the reserved memory resources.

S211: In response to the control information, deleting the information of the reserved memory resources in the secondary memory manager, adding the information of the reserved memory resources into the primary memory manager, and setting the attribute of the reserved memory resources as available to the primary system.

In block S211, the primary system may delete the information of the reserved memory resources in the secondary memory manager after having received the mission completion message from the secondary system. The information of the reserved memory resources may be added into the primary memory manager and the attribute of the reserved memory resources may be set as available to the primary system. In this way, the state of the reserved memory may be switched from “available to the secondary system but unavailable to the primary system” to “available to the primary system but unavailable to the secondary system”. In subsequent operations, the primary system may use the reserved memory resources by using the primary memory manger. In other words, the reserved memory resources are recycled. Since the secondary system cannot access the reserved memory resources in this situation, interruption of memory resources may be avoided.

As shown in FIG. 5, in some embodiments, information of the reserved memory resources may be deleted from the reserved memory lists including multiple memory blocks in the secondary memory manager, and then be added into the primary memory lists stored in the primary memory manager. Optionally, the reserved memory resources may be added in the idle memory lists in the primary memory manager such that normal function of memory resources will not be affected.

In some embodiments, the operation of adding the information of the reserved memory resources may be recorded so as to mark the recycled reserved memory resources. It should be understood, this operation may be performed by the primary system, the secondary system or both the two systems. It can be performed when the secondary system informs the primary system of the completion of its mission or after the reserved memory resources have been recycled.

S212: Recalculating the managing information of the primary memory manager of the primary system.

In some embodiments, the management information of the primary memory manger should be recalculated so as to better manage the information set of memory resources available to the primary system. The management information may include, but not limited to, size of memory resources, address range, control parameters or alarm thresholds. After the reserved memory resources have been recycled, the information of memory resources available to the primary system may be updated by recalculating the management information of the primary memory manager. In this way, the primary system may correctly call the memory resources recorded in the primary memory manager so as to execute tasks.

According to this embodiment, after the secondary system completes its mission, the reserved memory resources reserved for the secondary system may be recycled for the use of the primary system. By adjusting the information of memory resources stored in the secondary and primary memory managers and modifying the attribute of the reserved memory resources, the state of the reserved memory resources may be switched from “available to the secondary system but unavailable to the primary system” to “available to the primary system but unavailable to the secondary system” when required, such that the memory resources may be recycled.

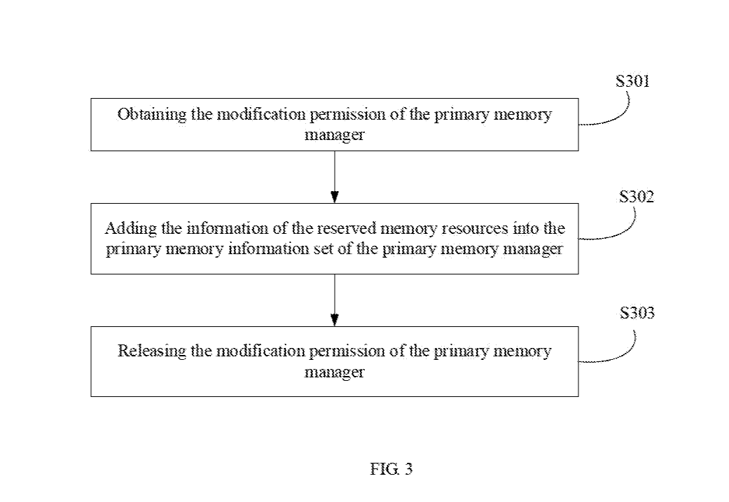

Referring to FIG. 3, FIG. 3 shows the method for adding the information of the reserved memory resources into the primary memory manager according to an embodiment of the present disclosure. The method may include operation described in following blocks S301˜S303.

S301: Obtaining the modification permission of the primary memory manager.

In some embodiments, the information of the reserved memory resources needs to be recorded in the primary memory manager, e.g., as described in block S211. At the same time, the primary system is still in normal function. Thus, the modification to the primary memory manager should not affect the calling function of the primary system to the memory resources recorded in the primary memory manager. In other words, the primary memory manger may be dynamically modified. In block S301, the modification permission of the primary memory manger may be firstly obtained. For example, for the manager buddy memory allocation, its memory lock may be firstly acquired such that the modification permission of the information of memory resources available to the primary system stored in the primary memory resources may be acquired.

S302: Adding the information of the reserved memory resources into the primary memory information set of the primary memory manager.

After the modification permission has been acquired, information of the reserved memory resources may be added into the information set of memory resources available to the primary system stored in the primary memory manager. It should be understood, the operation of adding the information of the reserved memory resources should not affect the normal function of the primary system. Thus, the information of the reserved memory resources may be added into idle lists of memory resources available to the primary system.

S303: Releasing the modification permission of the primary memory manager.

After the modification, the primary system may release the modification permission of the primary memory manager, and does not modify the recorded information any more. Thus, information of the reserved memory resources may be dynamically added into the information set of memory resources available to the primary system.

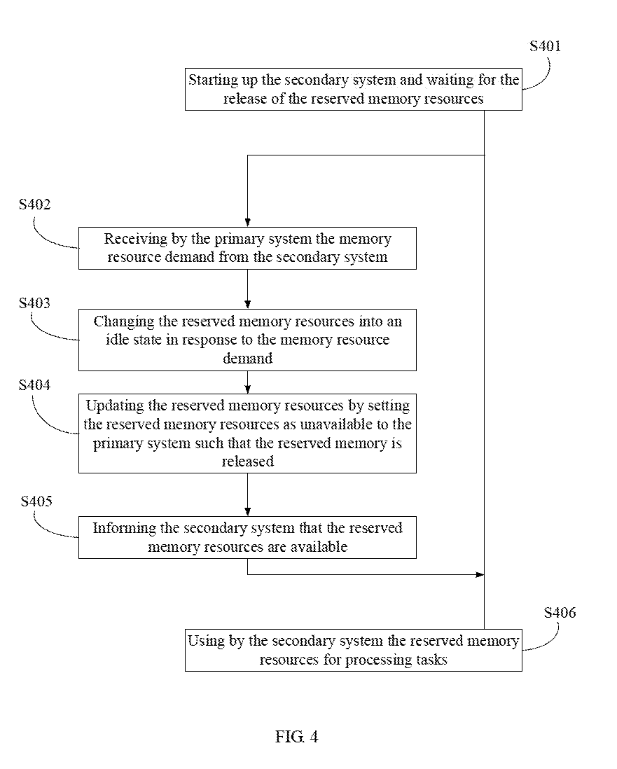

Referring to FIG. 4, FIG. 4 shows a flow chart of a method for reallocating memory resources according to an embodiment of the present disclosure. In some embodiments, the secondary system may restart after the completion of its mission in a certain period of time so as to execute the next mission. In this situation, the secondary system may not work normally unless proper memory resources are reallocated to the secondary system. Thus, the present disclosure further involves reallocating the recycled memory resources. As shown in FIG. 4, the method for reallocating memory resources after the reserved memory resources are recycled may include operations described in following block S401˜S406.

S401: Starting up the secondary system and waiting for the release of the reserved memory resources.

In block S401, the secondary system may be restarted. The secondary system may second a memory resource demand to the primary system so as acquire the reserved memory resources which have been recycled to execute its mission. In some embodiments, the reserved memory resources is being used by the primary system. Thus, the reserved memory resources should be released to avoid system errors.

S402: Receiving by the primary system the memory resource demand from the secondary system.

Correspondingly, the primary system may receive the memory resource demand.

S403: Changing the reserved memory resources into an idle state in response to the memory resource demand.

In block S403, the primary system may change the reserved memory resources into an idle state in response to the received memory resource demand. The primary system may record the secondary system corresponding to the reserved memory resources. Accordingly, when receiving the memory resource demand, the primary system may rapidly find out the corresponding secondary system.

Optionally, the operation for changing the reserved memory resources into an idle state may include: copying contents stored in the reserved memory resources to substitution memory resources, and modifying the mapping table between logical addresses and physical addresses such that logical addresses of the reserved memory resources may be modified to correspond to the substitution memory resources (e.g., by modifying the mapping relationship in the page table). The substitution memory resources may be any idle physical memory resources capable of storing the contents stored in the reserved memory resources. For example, the size of the substitution memory resources may be equal to or larger than that of the reserved memory resources. After the mapping relationship between the logical addresses and the physical addresses is modified, when the system tries to access the reserved memory resources according to its logical addresses, the system may actually access the substitution memory resources. Thus, the reserved memory resources may be changed into an idle state. Processes occupying the reserved memory resources may be paused during the substitution operation, and may be restarted when the substitution is completed, which will not affect the normal function of the primary system. It should be understood that, the contents stored in the reserved memory resources may further be emptied when necessary, which is not limited in the present disclosure.

It should be noticed that, when the primary system receives the memory resource demand and no idle substitution memory resources are available, it is possible to close some tasks or processes so as to obtain the idle substitution memory resources. For example, the primary system may pre-set a white list in which are recorded non-critical tasks and processes. When there is no substitution memory resources available, some of the processes recorded in the white list may be shut down. Thus, the substitution memory resources may be acquired without affecting the main function of system, which avoids potential system crashes.

S404: Updating the reserved memory resources by setting the reserved memory resources as unavailable to the primary system such that the reserved memory is released.

Different from the operation for recycling the reserved memory resources, in block S404, the primary system may update the reserved memory resources which has been changed to an idle state in previous steps and set the reserved memory resources as unavailable to the primary system. Similarly, the updating operation may be achieved by using memory manager or by directly modifying the attribute of the reserved memory resources. After the reserved memory is changed to be unavailable to the primary system, the primary system may no longer use the reserved memory resources to execute its tasks. Thus, the secondary system may call the reserved memory resources without affecting the normal function of the primary system.

In some embodiments, the method of setting the reserved memory resources as unavailable to the primary system may include: deleting the information of the reserved memory resources in the primary memory manager, adding the information of the reserved memory resources in the secondary memory manager and setting the attribute of the reserved memory resources as unavailable to the primary system. In this way, the state of the reserved memory resources may be switched from “available to the primary system but unavailable to the secondary system” to “available to the secondary system but unavailable to the primary system”.

At this point, the primary system finishes releasing the reserved memory resources which have been previously recycled.

S405: Informing the secondary system that the reserved memory resources are available.

In some embodiments, the primary system may send a notification message after having released the reserved memory resources so as to inform the secondary system that the reserved memory resources have been released and the secondary system is allowed to use the reserved memory resources.

S406: Using by the secondary system the reserved memory resources for processing tasks.

In response to the notification message from the primary system, the secondary system may use the reserved memory resources which have been released to execute tasks.

After the mission of the secondary system has been accomplished, the primary system may recycle the reserved memory resources again by using the above-described method for recycling memory resources. Thus, the process of “recycling, reallocating, recycling . . . ” may be realized. Therefore, the implementation of the present disclosure may improve the utilization of memory resources without affecting the normal function of the primary system and the secondary system.

The overall steps of the present disclosure will be explained below by taking an example of an Android system with a Linux kernel.

The main steps for recycling the reserved memory resources may include the following operations.

When the whole system is powered up, the operating system (i.e., the primary system) may acquire the size of real physical memory resources which include memory resources available to the operating system and the physical memory resources reserved for the rapid application. The operating system set up memory pages for the memory resources, mark the physical memory resources reserved for the rapid application as unavailable to the operating system, and store relative information in corresponding lists of the manager memblock.

Next, the operating system may set up the manager buddy memory allocation. The manager buddy memory allocation may be used to store the page information of physical memory resources available to the operating system. Since the reserved memory resources have been marked as unavailable to the operating system, the manager does not record relative information of the reserved memory resources. Thus, after the manager buddy memory allocation is initialized, the size of memory resources visible to the operating system may be equal to the overall size of all memory resources minus the size of the reserved memory resources (Total_size-reserve_sz).

After the operating system is started up, the operating system may use the memory resources recorded in the manager of buddy memory allocation rather than the reserved memory resources, and the reserved memory resources may be safely used by the rapid application.

After the start-up of the operating system is completed, the operating system may load a driving program to interchange information with external rapid application, for example, to receive the start or stop information of the external rapid application, so as to recycle the reserved memory resources.

The rapid application may send command to the operating system so as to inform the operating system to perform the operation of recycling memory resources when the task of the rapid application is accomplished.

When receiving the command received from the rapid application, the driving program may analyze the command. When it is determined that the command indicating that the rapid application is closed, the information of the physical memory resources reserved for the rapid application may be deleted from the lists of the manager of memblock, and the data structure of the manager may be updated by setting the page attribute of memory resources as available to the primary system.

The memory lock of the manager buddy memory allocation may be acquired. Thus, all the reserved memory resources may be dynamically added into idle lists of the manager buddy memory allocation. The data information of the manger buddy memory allocation may be updated based on the current state of system and the size of the reserved memory resources block, and then the memory block of the manager may be released. Subsequently, the management information of the manager buddy memory allocation may be recalculated according to the memory resources available to the current operating system and the idle memory resources, and then the system may be informed.

The main steps for reallocating the reserved memory resources for the secondary system may include the following operations.

The rapid application may ask the operating system for memory resources. When detecting the demand, the operating system may replace the reserved physical memory resources with other physical memory resources by modifying the mapping relationship of page table. After the reserved memory resources are replaced, the operating system may perform opposite steps compared with the method for recycling memory resources. The management information in the managers of buddy memory allocation and memblock may be updated so as to complete releasing the reserved memory resources.

The present disclosure may be implemented in various types of operating systems. For example, an on-board system of a vehicle may include a secondary system for reversing assistant. During the start-up process of the on-board system, the start-up of the secondary system for reversing assistant may be firstly completed, and then the secondary system may use the reserved memory resources to execute its tasks so as to respond to user's requirement rapidly. Thus, the user does not have to wait for the whole on-board system to start up, and may reverse the vehicle with the aid of the secondary system. After the reversing operation is performed, the secondary system for reversing assistant may send a message indicating that its mission is accomplished to the on-board system. Correspondingly, the on-board system may recycle the reserved memory resources according to the above-mentioned method. When the user needs to reverse the vehicle for a second time, the on-board system may release the recycled memory resources according to the above-mentioned method, and reallocate the reserved memory resources to the secondary system for reversing assistant. In this way, the secondary system for reversing assistant may be provided with necessary reserved memory resources to assist the user to reverse the vehicle when needed, and the primary system may use the reserved memory resources when the user does not perform the reversing operation. Thus, system performance may be improved. It should be understood that, the present disclosure may also be implemented in other scenarios where a primary system and at least one secondary system are present, e.g., processes for displaying screen protection during the start-up of a mobile terminal, other service processed operating before the completion of start-up of the operating system of a mobile terminal and the like.

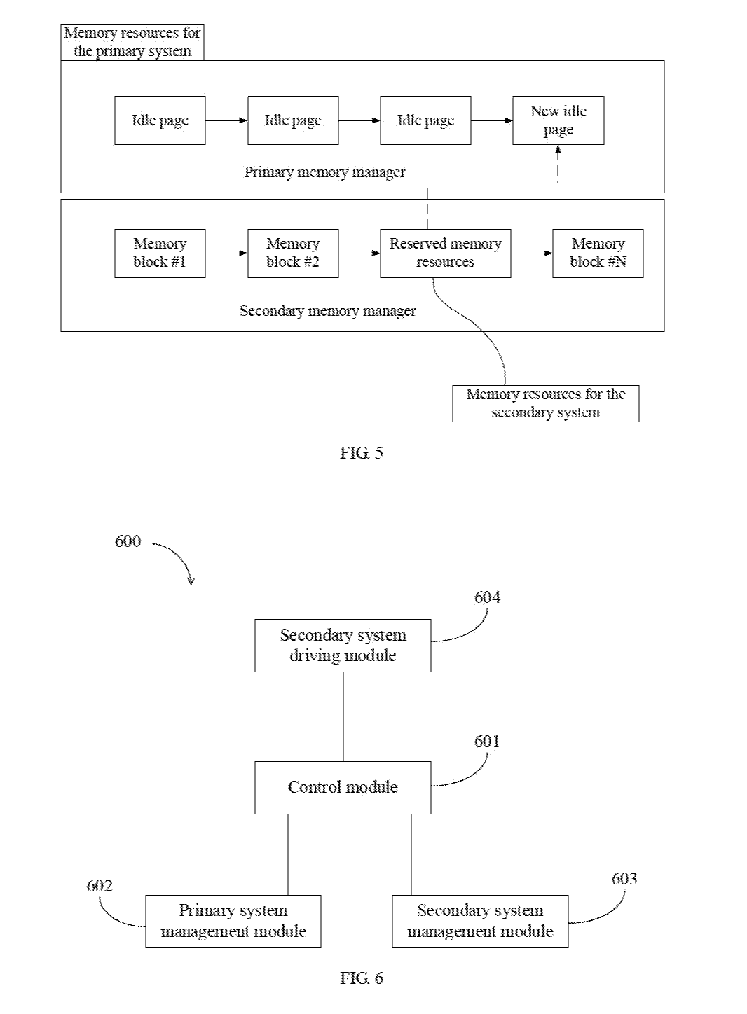

Referring to FIG. 6, the present disclosure may also provide a device for allocating memory resources. The device 600 may include a control module 601, a primary memory management module 602, a secondary memory management module 603 and a secondary system driving module 604. The control module 601 may divide memory resources into primary memory resources and reserved memory resources through the primary memory management module 602 and the secondary memory management module 603, wherein the reserved memory resources refer to the memory resources reserved for the use of a secondary System. The secondary system driving module 601 may be utilized to acquire a control information indicating that the mission of the secondary system is accomplished or will not be executed from the secondary system. Under the control of the control module 601, the primary memory management module 602 and the secondary memory management 603 may update the information of the reserved memory resources by setting the reserved memory resources as available to the primary system in response to the control information.

In some embodiments, the method for dividing memory resources into primary memory resources and reserved memory resources may include the following operations. The control module 601 may set the attribute of the reserved memory resources as unavailable to the primary system, and set the attribute of the primary memory resources as available to the primary system. The secondary memory management module 603 may set up a secondary memory manager, and record information of the reserved memory resources in the secondary memory manager. The primary memory management module 602 may set up a primary memory manager, and record information set of all memory resources available to the primary system in the primary memory manger.

In some embodiments, the control module 601 may set the page information of the reserved memory resources as unavailable to the primary system, and set the page information of the primary memory resources as available to the primary system. This availability-relative information may be stored in the kernel configuration file. The secondary memory management module 603 may access the kernel configuration file, and add information of the reserved memory resources in memory lists of the secondary memory manager according to the page information of the reserved memory resources. The primary memory management module 602 may access the kernel configuration file, and add information of the primary memory resources in memory lists of the primary memory manager according to the page information of the primary memory resources.

In some embodiments, the control module 601 may set the attribute of the reserved memory resources as available to the primary system in response to the control information indicating that the mission of the secondary system is accomplished or not executed acquired by the secondary system driving module 604. The secondary memory management module 603 may delete the information of the reserved memory resources in the secondary memory manager under the control of the control module 601, and the primary memory management module 602 may record the information of the reserved memory resources in the primary memory manager.

In some embodiments, after the reserved memory resources are updated as available to the primary system, the control module 601, the primary memory management module 602, the secondary memory management module 603 and/or the secondary system driving module 604 may record the updating operation and mark the reserved memory resources.

In some embodiments, when the reserved memory resources are updated as available to the primary system, the control module 601 may receive a memory resource demand from the secondary system through the secondary system driving module 604. In response to the memory resource demand, the control module 601 may search for the reserved memory resources based on the mark of the reserved memory resources, and change the reserved memory resources into an idle state. Furthermore, the control module 601 may update the reserved memory resources and set the reserved memory resources as unavailable to the primary system by using the primary management module 602 and the secondary management module 603 so as to release the reserved memory resources.

In some embodiments, in order to change the reserved memory resources into an idle state, the control module 601 may copy contents stored in the reserved memory resources to substitution memory resources, and modify the mapping table between logical addresses and physical addresses such that the logical addresses of the reserved memory resources may be modified to correspond to the substitution memory resources. The control module 601 may set the attribute of the reserved memory resources as unavailable to the primary system. Besides, under the control of the control module 601, the primary memory management module 602 may delete the information of the reserved memory resources in the primary memory manager, and the secondary memory management module 603 may record the information of the reserved memory resources in the secondary memory manger.

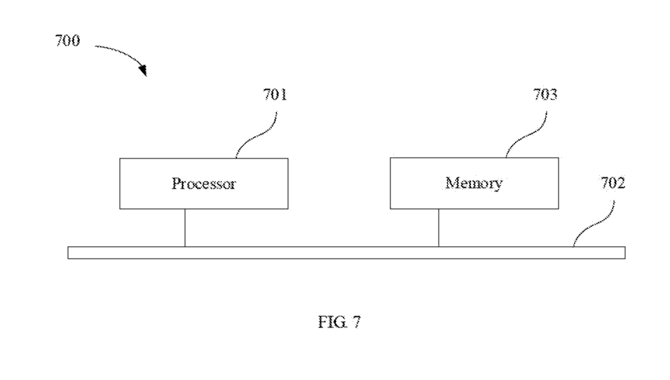

Referring to FIG. 7, the present disclosure also provides a chip. The chip 700 may include a processor 701, a communication bus 702 and a memory 703. The processor 701 and the memory 703 may be coupled through the communication bus 702. In some embodiments, the chip 700 may be a storage chip for an embedded system.

The memory 703 may be configured to store program instructions. The program instructions may be executed by the processor 701 to execute the method for allocating memory resources described in any one of the above embodiments. It should be understood, in some embodiments, the program instructions may be stored in an external storage device (e.g., hard disk, server etc.) rather than being stored in the chip 700. In this situation, the processor 701 of the chip 700 may read the program instructions stored in the external storage device and execute the method for allocating memory resources.

It should be noticed that the chip 700 may also be a chipset. For example, the primary system and the secondary system may be processed by two chips respectively. Each of the two chips may send interrupt messages to the other one through hardware circuits, and to acquire the information of modules of the other one based on the interrupt message. That is, the two chips may transmit signals therebetween.

It is to be understood that, the methods disclosed in the embodiments of the present disclosure may be implemented in the form of software functional units and utilized and sold independently. The above-mentioned modules may be stored in the ROM of a computing device. Based on this comprehension, the parts which contribute to the embodiments of the present disclosure may be implemented in the form of software product, and the software product may be stored in a storage medium including several instructions which is configured to execute all or part of the blocks described in the above-mentioned embodiments of the present disclosure on an electronic device such as a chip, a mobile terminal, a personal computer and the like. The above-mentioned storage medium may include: USB flash disk, mobile HDD, ROM, RAM, disk or any medium used for storing program code.

The foregoing is merely embodiments of the present disclosure, and is not intended to limit the scope of the disclosure. Any transformation of equivalent structure or equivalent process which uses the specification and the accompanying drawings of the present disclosure, or directly or indirectly application in other related technical fields, are likewise included within the scope of the protection of the present disclosure.

What is claimed is:

1. A method for allocating memory resources, comprising:
dividing memory resources into primary memory resources and reserved memory resources, wherein the reserved memory resources are reserved for a secondary system;
receiving a control information indicating that a mission of the secondary system is completed or not executed; and
in response to the control information, updating the reserved memory resources by setting the reserved memory resources as available to a primary system.

2. The method of claim 1, wherein the dividing the memory resources into the primary memory resources and the reserved memory resources comprises:
setting an attribute of the reserved memory resources as unavailable to the primary system, and setting an attribute of the primary memory resources as available to the primary system;
setting up a secondary memory manager;
adding information of the reserved memory resources into the secondary memory manager; and
setting up a primary memory manager, wherein the primary memory manager is configured to store a primary memory information set which records information of memory resources available to the primary system.

3. The method of claim 2, wherein
the setting the attribute of the reserved memory resources as unavailable to the primary system and setting the attribute of the primary memory resources as available to the primary system comprises:
setting memory page information of the reserved memory resources as unavailable to the primary system, setting memory page information of the primary memory resources as available to the primary system, and storing the memory page information of the reserved memory resources and the memory page information of the primary memory resources in a kernel configuration file;
the adding information of the reserved memory resources into the secondary memory manager comprises: the secondary memory manager accessing the kernel configuration file, and adding the reserved memory resources into a reserved memory list of the secondary memory manager based on the memory page information of the reserved memory resources; and
the primary memory manager is configured to access the kernel configuration file, and to add the primary memory resources into a primary memory list of the primary memory manager based on the memory page information of the primary memory resources.

4. The method of claim 2, wherein the updating the reserved memory resources by setting the reserved memory resources as available to the primary system comprises:
deleting the information of the reserved memory resources in the secondary memory manager;
adding the information of the reserved memory resources into the primary memory manager; and
setting the attribute of the reserved memory resources as available to the primary system.

5. The method of claim 1, further comprising:
recording the updating of the reserved memory resources and marking the reserved memory resources.

6. The method of claim 5, further comprising:
receiving a memory resource demand from the secondary system;
in response to the memory resource demand, searching for the reserved memory resources based on the marking of the reserved memory resources;
changing the reserved memory resources into an idle state; and
updating the reserved memory resources by setting the reserved memory resources as unavailable to the primary system such that the reserved memory resources are released.

7. The method of claim 6, wherein
the changing the reserved memory resources into the idle state comprises:
copying contents stored in the reserved memory resources to substitution memory resources; and
modifying a mapping table between logical addresses and physical addresses such that logical addresses of the reserved memory resources are set to correspond to the substitution memory resources;
the updating the reserved memory resources by setting the reserved memory resources as unavailable to the primary system comprises:
deleting the information of the reserved memory resources in the primary memory manager;
adding the information of the reserved memory resources into the secondary memory manager; and
setting the attribute of the reserved memory resources as unavailable to the primary system.

8. A chip comprising a processor, wherein the processor is configured to execute program instructions to execute a method for allocating memory resources, and the method comprises:
dividing memory resources into primary memory resources and reserved memory resources, wherein the reserved memory resources are reserved for a secondary system;
receiving a control information indicating that a mission of the secondary system is completed or not executed; and
in response to the control information, updating the reserved memory resources by setting the reserved memory resources as available to a primary system.

9. The chip of claim 8, wherein the dividing the memory resources into the primary memory resources and the reserved memory resources comprises:
setting an attribute of the reserved memory resources as unavailable to the primary system, and setting an attribute of the primary memory resources as available to the primary system;
setting up a secondary memory manager;
adding information of the reserved memory resources into the secondary memory manager; and
setting up a primary memory manager, wherein the primary memory manager is configured to store a primary memory information set which records information of memory resources available to the primary system.

10. The chip of claim 9, wherein
the setting the attribute of the reserved memory resources as unavailable to the primary system and setting the attribute of the primary memory resources as available to the primary system comprises:
setting memory page information of the reserved memory resources as unavailable to the primary system, setting memory page information of the primary memory resources as available to the primary system, and storing the memory page information of the reserved memory resources and the memory page information of the primary memory resources in a kernel configuration file;
the adding information of the reserved memory resources into the secondary memory manager comprises: the secondary memory manager accessing the kernel configuration file, and adding the reserved memory resources into a reserved memory list of the secondary memory manager based on the memory page information of the reserved memory resources; and
the primary memory manager is configured to access the kernel configuration file, and to add the primary memory resources into a primary memory list of the primary memory manager based on the memory page information of the primary memory resources.

11. The chip of claim 9, wherein the updating the reserved memory resources by setting the reserved memory resources as available to the primary system comprises:
deleting the information of the reserved memory resources in the secondary memory manager;
adding the information of the reserved memory resources into the primary memory manager; and
setting the attribute of the reserved memory resources as available to the primary system.

12. The chip of claim 9, wherein the method further comprising:
recording the updating of the reserved memory resources and marking the reserved memory resources.

13. The chip of claim 12, wherein the method further comprising:
receiving a memory resource demand from the secondary system;
in response to the memory resource demand, searching for the reserved memory resources based on the marking of the reserved memory resources;
changing the reserved memory resources into an idle state; and
updating the reserved memory resources by setting the reserved memory resources as unavailable to the primary system such that the reserved memory resources are released.

14. The chip of claim 13, wherein
the changing the reserved memory resources into the idle state comprises:
copying contents stored in the reserved memory resources to substitution memory resources; and
modifying a mapping table between logical addresses and physical addresses such that logical addresses of the reserved memory resources are set to correspond to the substitution memory resources;
the updating the reserved memory resources by setting the reserved memory resources as unavailable to the primary system comprises:
deleting the information of the reserved memory resources in the primary memory manager;
adding the information of the reserved memory resources into the secondary memory manager; and
setting the attribute of the reserved memory resources as unavailable to the primary system.

15. A non-transitory readable medium comprising program instructions that, when executed by a processor of an electronic device, cause the processor to perform a method for allocating memory resources, wherein the method comprises:
dividing memory resources into primary memory resources and reserved memory resources, wherein the reserved memory resources are reserved for a secondary system;
receiving a control information indicating that a mission of the secondary system is completed or not executed; and
in response to the control information, updating the reserved memory resources by setting the reserved memory resources as available to a primary system.

16. The non-transitory readable medium of claim 15, wherein the dividing the memory resources into the primary memory resources and the reserved memory resources comprises:
setting an attribute of the reserved memory resources as unavailable to the primary system, and setting an attribute of the primary memory resources as available to the primary system;
setting up a secondary memory manager;
adding information of the reserved memory resources into the secondary memory manager; and
setting up a primary memory manager, wherein the primary memory manager is configured to store a primary memory information set which records information of memory resources available to the primary system.

17. The non-transitory readable medium of claim 16, wherein
the setting the attribute of the reserved memory resources as unavailable to the primary system and setting the attribute of the primary memory resources as available to the primary system comprises:
setting memory page information of the reserved memory resources as unavailable to the primary system, setting memory page information of the primary memory resources as available to the primary system, and storing the memory page information of the reserved memory resources and the memory page information of the primary memory resources in a kernel configuration file;
the adding information of the reserved memory resources into the secondary memory manager comprises: the secondary memory manager accessing the kernel configuration file, and adding the reserved memory resources into a reserved memory list of the secondary memory manager based on the memory page information of the reserved memory resources; and
the primary memory manager is configured to access the kernel configuration file, and to add the primary memory resources into a primary memory list of the primary memory manager based on the memory page information of the primary memory resources.

18. The non-transitory readable medium of claim 16, wherein the updating the reserved memory resources by setting the reserved memory resources as available to the primary system comprises:
deleting the information of the reserved memory resources in the secondary memory manager;
adding the information of the reserved memory resources into the primary memory manager; and
setting the attribute of the reserved memory resources as available to the primary system.

19. The non-transitory readable medium of claim 15, wherein the method further comprises:
recording the updating of the reserved memory resources and marking the reserved memory resources;
receiving a memory resource demand from the secondary system;
in response to the memory resource demand, searching for the reserved memory resources based on the marking of the reserved memory resources;
changing the reserved memory resources into an idle state; and
updating the reserved memory resources by setting the reserved memory resources as unavailable to the primary system such that the reserved memory resources are released.

20. The non-transitory readable medium of claim 19, wherein
the changing the reserved memory resources into the idle state comprises:
copying contents stored in the reserved memory resources to substitution memory resources; and
modifying a mapping table between logical addresses and physical addresses such that logical addresses of the reserved memory resources are set to correspond to the substitution memory resources;
the updating the reserved memory resources by setting the reserved memory resources as unavailable to the primary system comprises:
deleting the information of the reserved memory resources in the primary memory manager;
adding the information of the reserved memory resources into the secondary memory manager; and
setting the attribute of the reserved memory resources as unavailable to the primary system.
